(19) United States
(12) Patent Application Publication
(10) Pub. No.: US 2009/0274368 A1
(43) Pub. Date: Nov. 5, 2009

(54) Image correction method and apparatus

(75) Inventor: Masahiro Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/458,384

(22) Filed: Jul. 9, 2009

Related U.S. Application Data
(63) Continuation of application No. PCT/JP07/50264, filed on Jan. 11, 2007.

(51) Int. Cl. G06K 9/00

(52) U.S. Cl. 382/167

(57) ABSTRACT

A computer readable storage medium contains instructions that, when executed by a computer, cause the computer to perform detecting a flat image portion having a color variation amount less than a predetermined amount from a specific color region having a specific color in an image, measuring a size of the flat image portion detected, and correcting the flat image portion by a first correction amount if the size of the flat image portion measured is larger than a predetermined value, and correcting the flat image portion by a second correction amount greater than the first second correction amount if the size of the flat image portion measured is not greater than the predetermined value.

### CROSS-REFERENCE TO RELATED APPLICATION(S)

This application is a continuation of PCT international application Ser. No. PCT/JP2007/050264 filed on Jan. 11, 2007 which designates the United States, incorporated herein by reference.

### FIELD

The embodiments discussed herein are directed to an image correction program, an image correction method, and an image correction apparatus.

### BACKGROUND

Various efforts have been made to correct images (adjust image quality) of televisions (TVs) and digital cameras. Memory colors (such as a skin color) are highly noted in images. Particularly, in an image including a person photographed as a main object, a skin color (memory color) region is detected from the image, and a tone and a hue thereof are corrected to a desired tone and a desired hue.

For example, in Japanese Laid-open Patent Publication No. 2005-276182 (p. 1, pp. 10-11, FIG. 6), a method of acquiring color information corresponding to a skin color is proposed. In this method, a specific portion crossing outlines of both sides of a nose of a face is referred to in an image, and any region that has the same color information is detected from the entire image as a skin region.

When an image correction is performed on such a detected region, an unnatural image may be generated, in which a boundary between a region to which the image correction has been performed and an adjacent region is prominent. In Japanese Laid-open Patent Publication No. 2000-224410 (p. 8, FIG. 21), for example, an apparatus is proposed, in which an image correction does not generate an unnatural image, by performing a smoothing process on the corrected region to smooth out a boundary portion between the corrected region and the non-corrected region.

In addition to the above-described technologies, in Japanese Laid-open Patent Publication No. 2005-25448 (p. 8, FIG. 2), a method of noting a pixel-level difference value in a local region to be corrected, performing an image correction of reducing a color saturation if the difference value is large, and searching for and removing chromatic difference of magnification (color blur due to lens) is also proposed

In the conventional technologies, a region detected as a memory color (specific color) and a memory color region subjectively identified by a user may sometimes be different, thereby generating an unnatural image in which a boundary has become prominent due to image correction.

This problem will be described in detail below with reference to FIGS. 13A to 13C. FIGS. 13A to 13C are explanatory diagrams for the problem in a conventional image correction apparatus. When a color of a person (skin color portion) photographed and a color of a region other than the skin color portion (such as a color in a background portion) closely resemble each other, a detected region (specific color region) and a region subjectively recognized as a skin color region by a user may be different. For example, in an image in which a beige region 5 corresponding to a signboard in the background is overlapped with a skin color region 2 of a face of the object photographed (see FIG. 13A), a skin color region 3 that is a beige color portion resembling the skin color in the signboard in the background is also detected as a skin color region (specific color region), together with a skin color region 1, the skin color region 2, and a skin color region 4 that are skin color regions of the person photographed (see FIG. 13B). When the image is corrected focusing mainly on the detected skin color regions, an unnatural image is generated, in which a boundary between the skin color region 3 that is the beige color portion resembling the skin color and the beige region 5 of the signboard in the background other than the skin color region 3 is prominent in the signboard in the background (see FIG. 13C).

### SUMMARY

According to an aspect of the invention a computer readable storage medium contains instructions that, when executed by a computer, cause the computer to perform detecting a flat image portion having a color variation amount less than a predetermined amount from a specific color region having a specific color in an image, measuring a size of the flat image portion detected, and correcting the flat image portion by a first correction amount if the size of the flat image portion measured is larger than a predetermined value, and correcting the flat image portion by a second correction amount greater than the first second correction amount if the size of the flat image portion measured is not greater than the predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIGS. 1A to 1D are explanatory diagrams for an outline and characteristics of an image correction apparatus according to a first embodiment of the present invention;

FIG. 2 is a block diagram of a configuration of the image correction apparatus according to the first embodiment;

FIG. 3 is an explanatory diagram for an example of a process of detecting a specific color region according to the first embodiment;

FIG. 4 is an explanatory diagram for an example of a process of measuring a color variation amount according to the first embodiment;

FIG. 5 is an explanatory diagram for an example of a process of detecting flat pixels according to the first embodiment;

FIG. 6 is an explanatory diagram for an example of a process of generating a flat image portion map image according to the first embodiment;

FIG. 7 is an explanatory diagram for an example of a process of detecting a flat image portion according to the first embodiment;

FIG. 8 is an explanatory diagram for an example of a process of setting a correction amount for the specific color region according to the first embodiment;

FIG. 9 is a flowchart of an image correction process according to the first embodiment;

FIGS. 10A to 10D are explanatory diagrams for characteristics of an image correction apparatus according to a second embodiment of the present invention;

FIGS. 11A to 11D are explanatory diagrams for an outline and characteristics of an image correction apparatus according to a third embodiment of the present invention;

FIG. 12 is a diagram illustrating a computer program for the image correction apparatus according to the first embodiment; and

FIGS. 13A to 13C are explanatory diagrams for the problem in the conventional image correction apparatus.

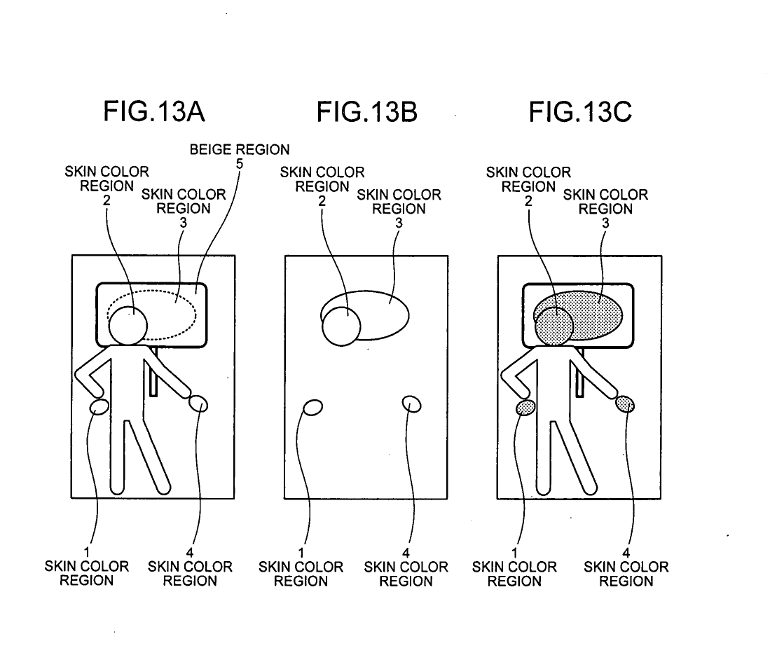

### DESCRIPTION OF EMBODIMENT(S)

Exemplary embodiments of an image correction program, an image correction method, and an image correction apparatus according to the present invention are described in detail below with reference to the accompanying drawings. An image correction apparatus and the like according to the present invention are applicable to all sorts of apparatuses that display an image, such as a TV, a digital camera, a known personal computer, a work station, a mobile phone, a personal handyphone system (PHS) terminal, a mobile communication terminal, and a personal digital assistant (PDA).

### [a] First Embodiment

Explanation of Terminology

Main terms used in the present embodiments will now be described. A “color variation” used in the present embodiments is a difference in colors between images of adjacent regions. More specifically, the “color variation” is a difference value obtained by comparing a pixel average value of pixels that constitute a first image in a first region with a pixel average value of pixels that constitute a second image in a second region adjacent to the first region. For example, when images of two adjacent regions having a large color variation amount are compared with the eye, colors of these images are subjectively recognized as more non-resembling as compared with images of two adjacent regions having a small color variation. When images of two adjacent having a small color variation amount are compared with the eye, colors of these images are subjectively recognized as more resembling as compared with images of two adjacent regions having a large color variation amount.

Outline and Characteristics of Image Correction Apparatus

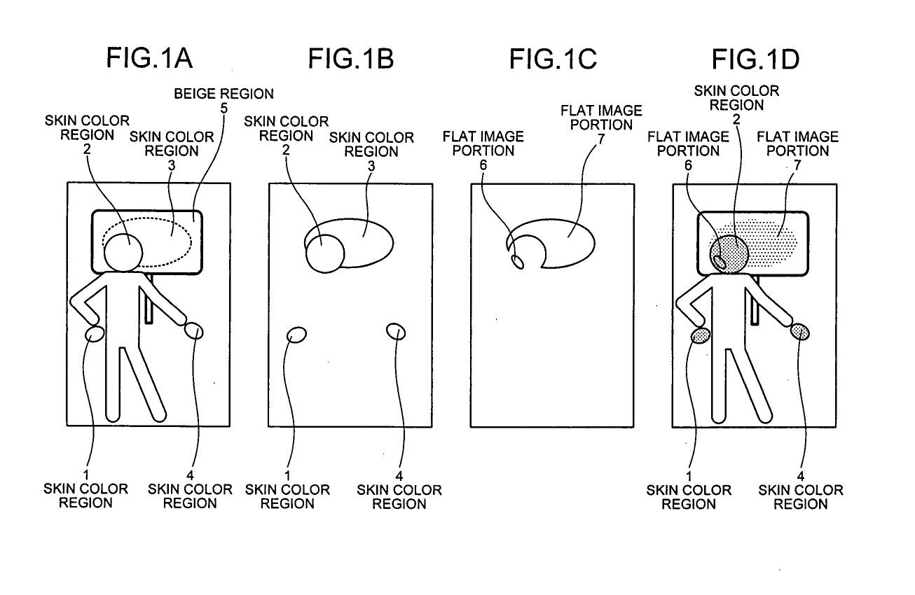

With reference to FIGS. 1A to 1D, an outline and characteristics of an image correction apparatus according to a first embodiment will be described. FIGS. 1A to 1D are explanatory diagrams for the outline and characteristics of the image correction apparatus according to the first embodiment.

The image correction apparatus according to the first embodiment is an image correction apparatus that detects and corrects a specific color region, which is an image region having a specific color, as an object to be corrected, from an image. As described below, one of the main characteristics of the image correction apparatus is in that the apparatus prevents generation of an unnatural image in which a boundary in a part of a corrected background is prominent, upon correction of the specific color region.

As illustrated in FIGS. 1A to 1D, the image correction apparatus according to the first embodiment detects, when an image is input, the specific color region from the image as the object to be corrected. For example, when an image including a beige region 5 that is beige in color of a signboard in a background overlaps a skin color region 2 of a person photographed is input (see FIG. 1A), the image correction apparatus, as illustrated in FIG. 1B, detects a skin color region 1, a skin color region 2, and a skin color region 4 that are skin color regions of the person photographed. The image correction apparatus also detects a skin color region 3 that is a beige color portion resembling a skin color in the beige region 5 of the beige colored signboard, as an image region having the skin color (specific color).

The image correction apparatus according to the first embodiment detects a flat image portion having a little color variation amount from an image in the specific color region. More specifically, the image correction apparatus obtains a color variation amount for each pixel forming the detected specific color region (image), and determines whether the color variation amount is smaller than a predetermined value for each pixel. If the color variation amount is smaller than the predetermined value, that pixel is determined to be a flat pixel. If the color variation is not smaller than the predetermined value, the pixel is determined not to be the flat pixel. The image correction apparatus according to the first embodiment then detects as a flat image portion a region (image) formed of the pixels determined to be the flat pixels, independently for each flat image portion.

For example, as illustrated in FIG. 1C, the image correction apparatus according to the first embodiment detects a flat image portion 6 that is a part of the skin color region 2, as a flat image portion, from among the skin color region 1, the skin color region 2, the skin color region 3, and the skin color region 4 that are the detected skin color regions (specific color regions). The image correction apparatus also detects a flat image portion 7 that is a part of the skin color region 3 which is the skin color region detected from the signboard in the background.

The image correction apparatus according to the first embodiment measures a size of the detected flat image portion. If the size of the flat image portion is larger than a predetermined value, the image correction apparatus corrects an image of the flat image portion by a smaller correction amount than that by which a small flat image portion is corrected. If the size of the flat image portion is not greater than the predetermined value, the image correction apparatus corrects the image of the flat image portion by a larger correction amount than that by which a large flat image portion is corrected. In other words, if the size of the flat image portion is larger than the predetermined value, the image correction apparatus corrects the image of the flat image portion by a smaller correction amount than that by which a flat image portion of a size not greater than the predetermined value is corrected. If the size of the flat image portion is not greater than the predetermined value, the image correction apparatus corrects the image of the flat image portion by a larger correction amount than that by which a flat image portion of a size greater than the predetermined value is corrected. For example, as illustrated in FIG. 1D, the image correction apparatus measures sizes of the flat image portion 6 and the flat image portion 7 detected as flat image portions, determines that the flat image portion 6 is not greater than a predetermined size, corrects the flat image portion 6 by a large correction amount, determines that the flat image portion 7 is larger than a predetermined size, and corrects the flat image portion 7 by a small correction amount.

The image correction apparatus according to the first embodiment performs the correction by setting the correction amount depending on the size of the flat image portion. Accordingly, as described above, it is possible to prevent generation of an unnatural image in which a boundary in a part of the corrected background is prominent, upon correction of the specific color region. In other words, for example, in an image including a person with a beige colored background, even if not only a portion of the person photographed but a part of the background is detected and corrected as the specific color region, it is possible to prevent generation of an unnatural corrected image in which a boundary in a part of the corrected background is prominent.

Configuration of Image Correction Apparatus

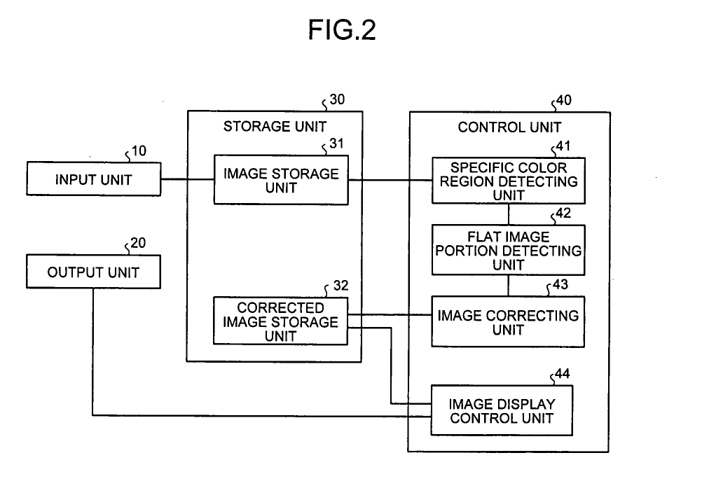

With reference to FIG. 2, a configuration of the image correction apparatus according to the first embodiment will be described. FIG. 2 is a block diagram of a configuration of the image correction apparatus according to the first embodiment. As illustrated in the diagram, the image correction apparatus includes an input unit 10, an output unit 20, a storage unit 30, and a control unit 40.

The input unit 10 receives an image input and the like. For example, the input unit 10 receives image data and basic information on a specific color region from a data input device (such as a floppy disk (FD) and a magneto-optical (MO) disk). The basic information is data indicating candidate regions for a face and skin portion (specific color region) notified as regions surrounded with rectangles, i.e., as upper-left coordinates (X1, Y1) and lower-right coordinates (X2, Y2). The candidate regions are obtained by a face searching program and the like provided separately. The output unit 20 outputs an image on which image correction has been performed by the control unit 40, which will be described later. For example, the output unit 20 displays characters and graphics on a display (such as a liquid crystal display and an organic electroluminescence (EL) display).

The storage unit 30 stores therein data and a computer program or programs required in various processes. As those closely related to the present invention, as illustrated in FIG. 2, the storage unit 30 includes an image storage unit 31 and a corrected image storage unit 32. The image storage unit 31 stores therein an image (input image) received from the input unit 10, and is formed of a memory or the like. The corrected image storage unit 32 stores therein an image on which image correction has been performed by the control unit 40, which will be described later, and is formed of a memory or the like.

The control unit 40 includes a control program such as an operating system (OS), and an internal memory to store therein a computer program or programs defining various types of processing procedures and required data, and executes various processes using them. As those closely related to the present invention, as illustrated in FIG. 2, the control unit 40 includes a specific color region detecting unit 41, a flat image portion detecting unit 42, an image correcting unit 43, and an image display control unit 44.

The specific color region detecting unit 41 detects a specific color region that is an image region having a specific color from an image, as an object to be corrected. More specifically, when the image (input image) is received from the input unit 10, the specific color region detecting unit 41 detects the specific color region having the specific color (such as a skin color) from the image.

For example, upon receiving an image from the input unit 10, the specific color region detecting unit 41 detects pixels that form an image corresponding to a region indicated by the basic information for a specific color (such as a skin color) region, from the received image (input image). The specific color region detecting unit 41 then calculates an average value ave (such as Rave, Gave, and Bave) of the detected pixels and a standard deviation dev (such as Rdev, Gdev, and Bdev) that is a standard deviation of the pixel average value. The specific color region detecting unit 41, using the average value ave and the standard deviation dev, determines a specific color range (such as Rskinrange, Gskinrange, and Bskinrange) that is a range in which a specific color (such as a skin color) is distributed. The following are examples of equations that determine the specific color range. In the following equations, α is a parameter to adjust and determine the specific color range, and is empirically determined in advance.

(Rave)−α×(Rdev)≦(Rskinrange)≦(Rave)+α×(Rdev)

(Gave)−α×(Gdev)≦(Gskinrange)≦(Gave)+α×(Gdev)

(Bave)−α×(Bdev)≦(Bskinrange)≦(Bave)+α×(Bdev)

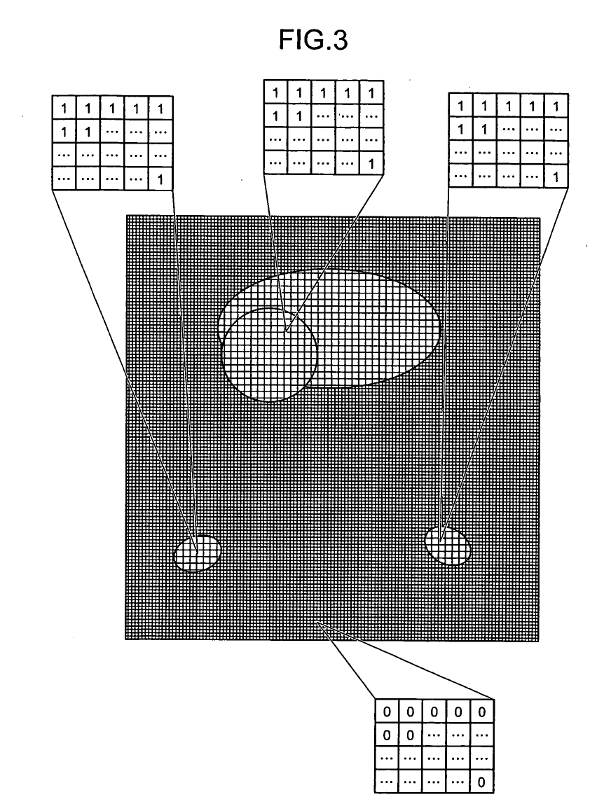

The specific color region detecting unit 41 then generates a mask map image that indicates whether each of pixels that form the image (input image) received from the input unit 10 is a pixel corresponding to the specific color range. More specifically, as illustrated in FIG. 3, the specific color region detecting unit 41 determines whether each of the pixels forming the input image is the pixel corresponding to the specific color range, and if the pixel is the pixel corresponding to the specific color range, the specific color region detecting unit 41 determines that the pixel has the specific color, and inputs “1” to the same coordinates in the mask map image. If the pixel is not the pixel corresponding to the specific color range, the specific color region detecting unit 41 does not determine that the pixel has the specific color, and inputs “0” to the same coordinates in the mask map image. FIG. 3 is an explanatory diagram for an example of a process of detecting the specific color region according to the first embodiment.

The flat image portion detecting unit 42 detects a flat image portion that has a small color variation amount from an image of the specific color region. More specifically, the flat image portion detecting unit 42 calculates the color variation amount for each pixel that forms the detected specific color region (image), selects a pixel from the specific color region, and determines whether the color variation amount of the pixel is smaller than a predetermined value. If the color variation amount is smaller than the predetermined value, the pixel is determined to be a flat pixel, and if the color variation value is not smaller than the predetermined value, the pixel is determined not to be the flat pixel. The flat image portion detecting unit 42 performs the same determination on all the pixels in the specific color region or regions. The flat image portion detecting unit 42 then detects as a flat image portion/portions a region/regions (image/images) formed of the pixels determined to be the flat pixels, each as an independent region.

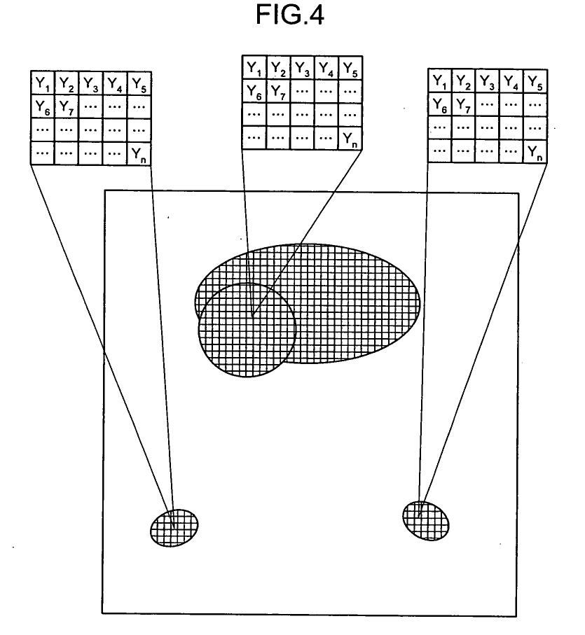

For example, as illustrated in FIG. 4, the flat image portion detecting unit 42 detects from the input image a pixel Pix that is a pixel having the same coordinates as those (coordinates for the pixel determined to have the specific color) at which “1” has been input in the mask map image. The flat image portion detecting unit 42 then extracts pixels distributed around the pixel Pix within a preset range from the input image, and calculates a gray scale value Y that is a gray scale value calculated for each of the extracted pixels. The following is an example of a general equation for calculating the gray scale value. A standard deviation devY that is a standard deviation for the gray scale value Y is then calculated. FIG. 4 is an explanatory diagram for an example of a process of measuring the color variation amount according to the first embodiment.

Y(gray scale value)=0.3×R+0.6×G+0.1×B

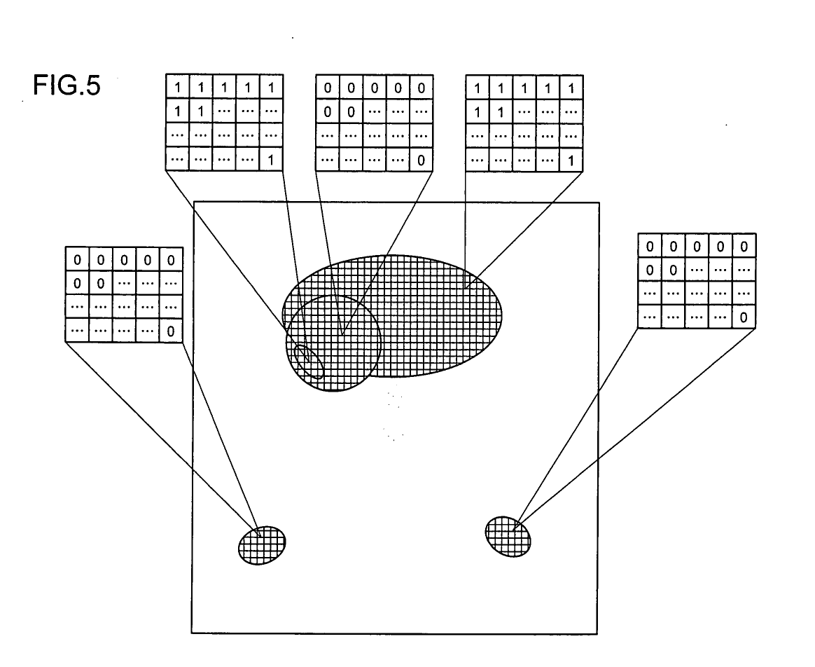

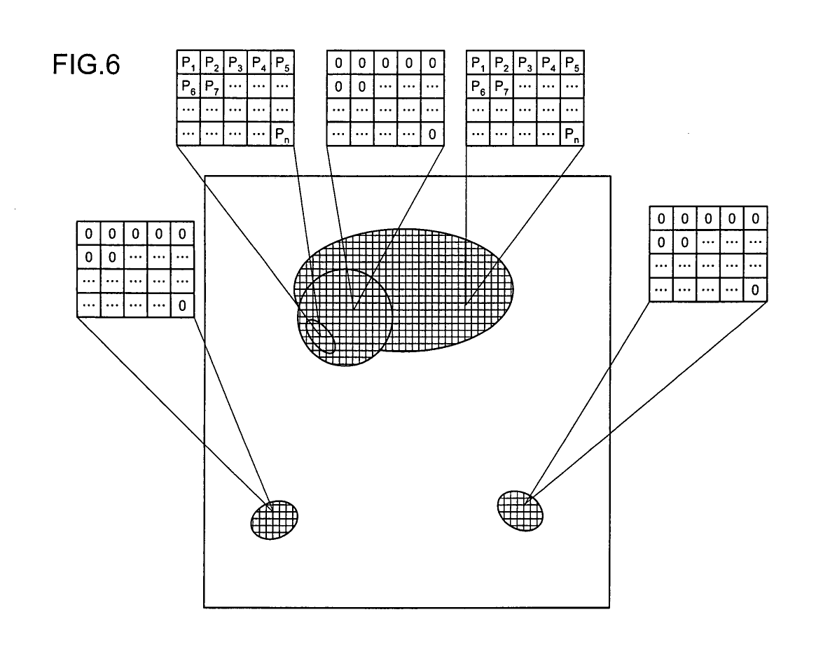

The flat image portion detecting unit 42 then generates a flat image portion map image, by comparing the standard deviation devY and a threshold Th1 that is a preset threshold. More specifically, as illustrated in FIG. 5, the flat image portion detecting unit 42 selects one pixel from the specific color region, and compares the standard deviation devY and the threshold Th1 for the pixel. If the standard deviation devY is smaller than the threshold Th1, the flat image portion detecting unit 42 determines that the extracted pixel is of the flat region and inputs “1” to the same coordinates in the flat image portion map image. If the standard deviation devY is not smaller than the threshold Th1, the flat image portion detecting unit 42 determines that the extracted pixel is not of the flat region, and inputs “0” to the same coordinates in flat image portion map image (see FIG. 5). Subsequently, as illustrated in FIG. 6, the flat image portion detecting unit 42 inputs a pixel value Pn of the pixel Pix at the same coordinates, into the coordinates at which “1” has been input in the flat image portion map image. FIG. 5 is an explanatory diagram for an example of a process of detecting the flat pixel according to the first embodiment. FIG. 6 is an explanatory diagram for an example of a process of generating the flat image portion map image according to the first embodiment.

The image correcting unit 43 measures a size of each of the detected flat image portions, and performs correction. More specifically, the image correcting unit 43 measures a proportion of an area occupied by each flat image portion to an area of the entire image, as the size of the flat image portion. If the size of the flat image portion is greater than a predetermined value, the image correcting unit 43 corrects an image of the flat image portion by a correction amount smaller than that by which a small flat image portion is corrected. If the size of the flat image portion is not greater than the predetermined value, the image correcting unit 43 corrects the image of the flat image portion by a correction amount larger than that by which a large flat image portion is corrected. That is, if the size of the flat image portion is greater than the predetermined value, the image correcting unit 43 corrects the image of the flat image portion by a correction amount smaller than that by which the flat image portion not larger than the predetermined value is corrected. If the size of the flat image portion is not greater than the predetermined value, the image correcting unit 43 corrects the image of the flat image portion by a correction amount larger than that by which the flat image portion larger than the predetermined value is corrected.

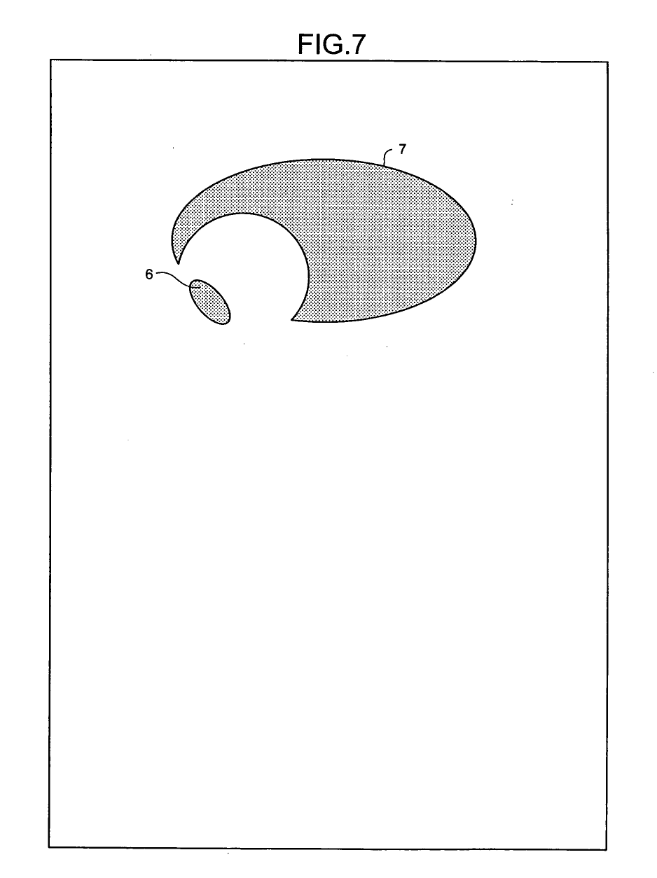

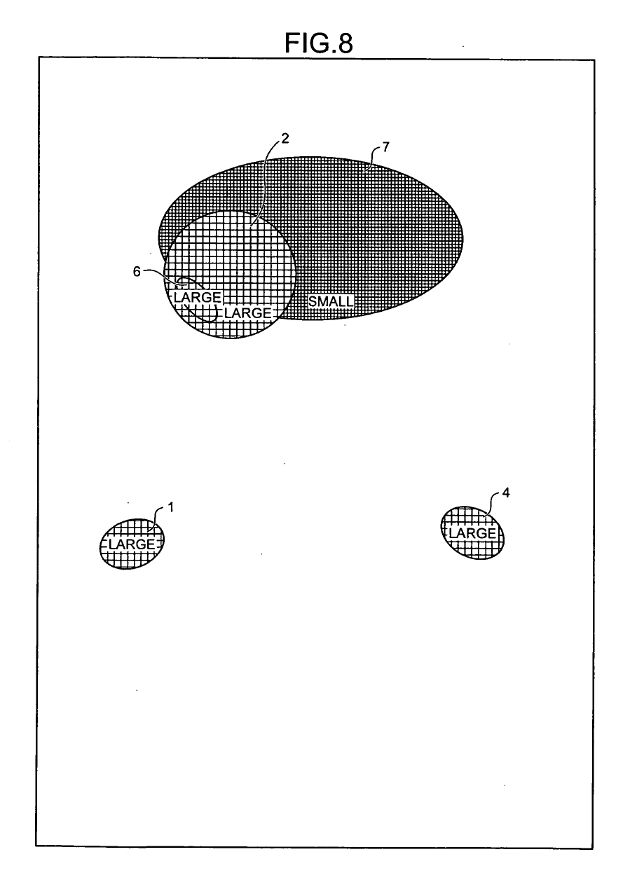

More specifically, as illustrated in FIG. 7, the image correcting unit 43 measures the size of each of the detected flat image portions. For example, in an example illustrated in FIG. 8, the image correcting unit 43 selects one flat image portion, and when the size of the flat image portion is larger than a predetermined value, sets a smaller correction amount than a correction amount set for a flat image portion not larger than the predetermined value (for example, see the region 7 in FIG. 8). If the size of the flat image portion is not greater than the predetermined value, the image correcting unit 43 sets a larger correction amount than a correction amount for a flat image portion larger than the predetermined value (for example, see the region 6 in FIG. 8). Subsequently, the image correcting unit 43 makes the determination on all the flat image portions, and sets the correction amounts. The image correcting unit 43 also sets a normal correction amount (such as the correction amount set for the flat image portion not greater than the predetermined value) for regions other than the flat image portions (such as the region 1, region 2, and region 4 in FIG. 8). The image correcting unit 43 performs image correction on the flat image portions, by using the correction amounts set for each pixel. For example, the flat image portion 6 is corrected by a large correction amount, and the flat image portion 7 is corrected by a small correction amount (see FIG. 1D). The skin color region 1, the skin color region 2, and the skin color region 4 that are skin color regions other than the flat image portions are corrected by a normal correction amount (large correction amount). The image correcting unit 43 then stores the corrected image in the corrected image storage unit 32. FIG. 7 is an explanatory diagram for an example of a process of detecting the flat image portion according to the first embodiment. FIG. 8 is an explanatory diagram for an example of a process of setting the correction amount for the specific color region according to the first embodiment.

For example, the image correcting unit 43 performs a smoothing process on a mask map image. More specifically, the image correcting unit 43, by using a simple smoothing filter, for example, adopts a filter size of 5×5, for example, and sets the pixel values in the mask map image to be continuous and smoothed. The image correcting unit 43 regards the flat image portion that are formed of pixels for which “0” has not been input and surrounded by pixels for which “0” has been input in the flat image portion map image, as an independent flat image portion. The image correcting unit 43 calculates a number of counts obtained by counting the number of pixels, for each flat image portion. If the number for the flat image portion is larger than a preset threshold Th2, the image correcting unit 43 corrects the flat image portion by performing a control of reducing the color correction amount to a correction amount smaller than that by which a flat image portion not larger than a size corresponding to the preset threshold Th2 is corrected. If the number of counts for the flat image portion is not greater than the preset threshold Th2, the image correcting unit 43 corrects the flat image portion without performing a control of increasing or decreasing the color correction amount.

More specifically, the image correcting unit 43, when performing a gamma curve process to convert an input image into a brighter image (if a gamma value is set at “0.5” to convert an image into a brighter image) upon image correction, if the number of counts is larger than the threshold Th2 (if the flat image portion is large), the image correction is performed by setting a correction amount less than the gamma value “0.5” to obtain a corrected input image. If the number of counts is not greater than the threshold Th2 (if the flat image portion is small), the image correction is performed by setting the gamma value at “0.5” to obtain the corrected input image.

Subsequently, the image correcting unit 43 generates a corrected image that is an image to be output, by using the input image and the mask map image. More specifically, the image correcting unit 43 generates the corrected image by superposing the input image and the corrected input image. In the superposing process, weighting is performed by using the continuous values obtained in the smoothing process. For example, a weight value is set by performing the following weighting. If the weight value is large, the corrected input image is emphasized more and the input image is emphasized less as compared with a case in which the weight value is small. If the weight value is small, the corrected input image is emphasized less and the input image is emphasized more as compared with a case in which the weight value is large.

(pixel value of mask map image=0): (weight value=0.0)
(pixel value of mask map image=0.5): (weight value=0.5)
(pixel value of mask map image=1): (weight value=1.0)

More specifically, the image correcting unit 43 generates a corrected image using the following equation. In the equation, “W” is the weight value, and f is a function representing a color correction process (such as the gamma curve process).

(Corrected image)=W×f(input image)+(1−W)×(input image)

The image display control unit 44 outputs the corrected image corrected by the image correcting unit 43 and stored in the corrected image storage unit 32 through the output unit 20.

Process by Image Correction Apparatus

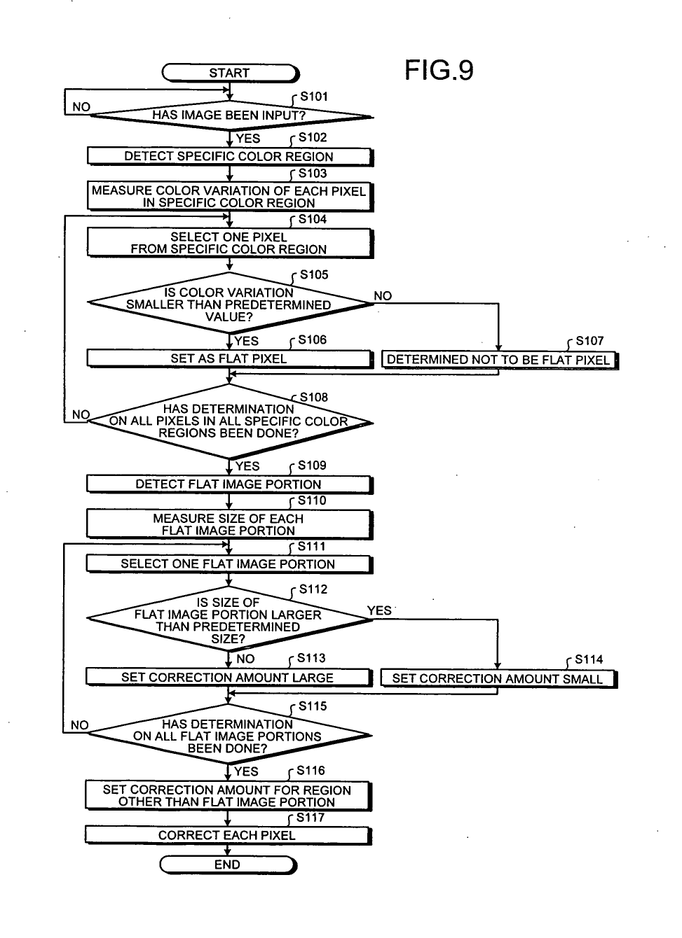

With reference to FIG. 9, procedural steps performed by the image correction apparatus according to the first embodiment will be described. FIG. 9 is a flowchart of an image correction process according to the first embodiment.

As illustrated in FIG. 9, the specific color region detecting unit 41, if there is an image (input image) input by the input unit 10 (Yes at Step S101), extracts a specific color region (such as a skin color region) (Step S102).

The flat image portion detecting unit 42 measures a color variation amount of each pixel in the specific color region (Step S103). The flat image portion detecting unit 42 then selects a pixel from the specific color region (Step S104). Subsequently, the flat image portion detecting unit 42 determines whether the color variation amount of the pixel is smaller than a predetermined value (Step S105). If the color variation amount of the pixel is smaller than the predetermined value (Yes at Step S105), the pixel is determined to be a flat pixel (Step S106). If the color variation amount of the pixel is not smaller than the predetermined value (No at Step S105), the pixel is determined not to be the flat pixel (Step S107). If all the pixels in all the specific color regions have been determined (Yes at Step S108), a flat image portion is extracted (Step S109). In other words, the flat image portion detecting unit 42 detects as the flat image portion/portions a region/regions (image/images) formed of the pixels determined to be the flat pixels, each as an independent region.

If all the pixels in all the specific color regions have not yet been determined (No at Step S108), the flat image portion detecting unit 42 returns to Step S104, again selects another pixel and makes the determination, to make the same determination on all of the pixels (Steps S104 to S108).

After the flat image portion is detected (Step S109), the image correcting unit 43 measures a size of each region detected as the flat image portion (detected flat image portion) (Step S110). The image correcting unit 43 then selects a flat image portion (Step S111), and determines whether the size of the flat image portion is larger than a predetermined size (Step S112). If the size of the flat image portion is not larger than the predetermined size (No at Step S112), a large correction amount is set (Step S113). If the size of the flat image portion is larger than the predetermined size (Yes at Step S112), a small correction amount is set (Step S114). If determination on all the flat image portions have been made (Yes at Step S115), a normal correction amount is set for regions other than the flat image portions (Step S116).

If determination on all the flat image portions have not yet been determined (No at Step S115), the image correcting unit 43 again selects another flat image portion and makes the determination to make the same determination on all the flat image portions (Steps S111 to S115).

The image correcting unit 43, by using the correction amount set for each pixel, performs image correction on the flat image portion (Step S117). In other words, the flat image portion determined to be not larger than the predetermined size is corrected by the large correction amount, and the flat image portion determined to be larger than the predetermined size is corrected by the small correction amount. The skin color regions other than the flat image portions are corrected by the normal correction amount.

Effects of First Embodiment

As described above, according to the first embodiment, the image correction apparatus detects the flat image portion having the small color variation amount from the image of the specific color region, and measures the size of the flat image portion. If the size of the flat image portion is larger than the predetermined value, the image correction apparatus corrects the image of the flat image portion by the smaller correction amount than that by which the flat image portion not larger than the predetermined size is corrected. If the flat image portion is not larger than the predetermined value, the image correction apparatus corrects the image of the flat image portion by the larger correction amount than that by which the flat image portion larger than the predetermined size is corrected. Accordingly, when the specific color region is corrected, it is possible to prevent generation of an unnatural image including a prominent boundary in a part of the corrected background.

According to the first embodiment, the image correction apparatus measures the proportion of the area occupied by each flat image portion to the area of the entire image, as the size of the flat image portion. Accordingly, when the specific color region is corrected, it is possible to correctly acquire the sizes of the flat image portions even if the image sizes are different, and to prevent an unnatural image including a prominent boundary in a part of the corrected background from being generated.

### [b] Second Embodiment

In the first embodiment, when the size of the flat image portion is larger than the predetermined value, the flat image portion is corrected using the small correction amount. However, the present invention is not limited to the first embodiment. If the size of the flat image portion is large, the flat image portion may not be necessarily corrected.

As a second embodiment, an example in which a correction is not made when a size of a flat image portion is larger than a predetermined value will be explained. Similar features to those in the image correction apparatus according to the first embodiment will be described briefly.

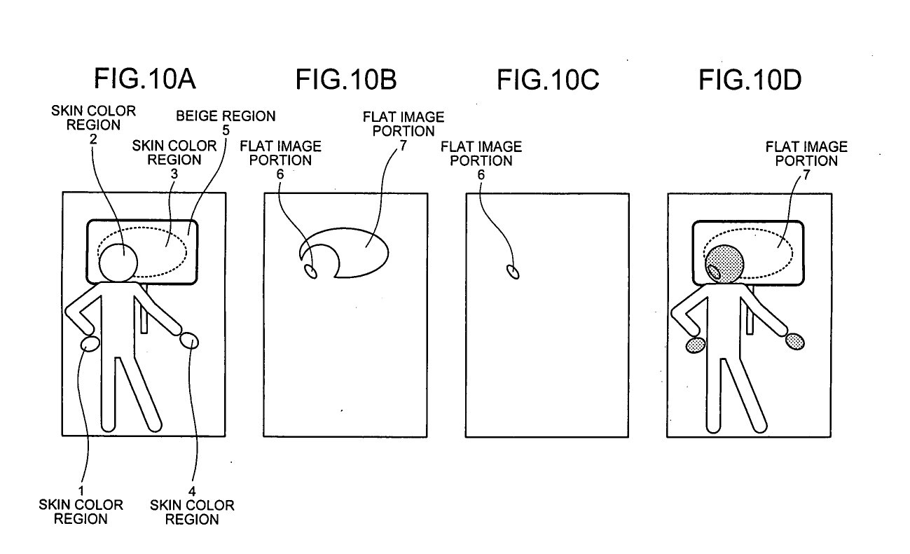

With reference to FIGS. 10A to 10D, an image correction apparatus according to the second embodiment will be described. FIGS. 10A to 10D are explanatory diagrams for characteristics of the image correction apparatus according to the second embodiment. As illustrated in FIGS. 10A to 10D, the image correction apparatus according to the second embodiment, when an image is input (see FIG. 10A), detects a flat image portion (such as the flat image portion 6 and the flat image portion 7 in FIG. 10B) from an image of a specific color region, and measures a size of the detected flat image portion (see FIG. 10B).

The image correction apparatus according to the second embodiment does not perform an image correction on the flat image portion having a size larger than a predetermined value. For example, if the size of the flat image portion is larger than a predetermined size, the image correction apparatus sets a correction amount as “0”, and does not perform a correction on the region for which the correction amount has been set as “0”. In other words, the region is excluded from a target to be corrected (see FIG. 10C). For example, as illustrated in FIG. 10B, the image correction apparatus measures the sizes of the flat image portion 6 and the flat image portion 7 detected as the flat image portions, determines that the flat image portion 6 is not larger than the predetermined size, and corrects the flat image portion 6 by a large correction amount. The image correction apparatus determines that the flat image portion 7 is larger than the predetermined size and does not correct the flat image portion 7 (see FIG. 10D).

According to the second embodiment, the image correction apparatus does not correct the image of the flat image portion if the size of the flat image portion is larger than the predetermined value. Accordingly, when the specific color region is corrected, it is possible to prevent an unnatural image including a prominent boundary in a part of the corrected background from being generated, while realizing an even more simplified correction process.

### [c] Third Embodiment

In the first and second embodiments, the image correction is performed regardless of an image adjacent to the detected flat image portion. However, the present invention is not limited these embodiments. The flat image portion may be extended to an adjacent image, and the extended flat image portion may be unitarily corrected.

As a third embodiment, an example in which a flat image portion is extended to an adjacent image, and a correction is made unitarily on the extended flat image portion will be explained. Similar features to those of the image correction apparatus according to the first and second embodiments will be described briefly.

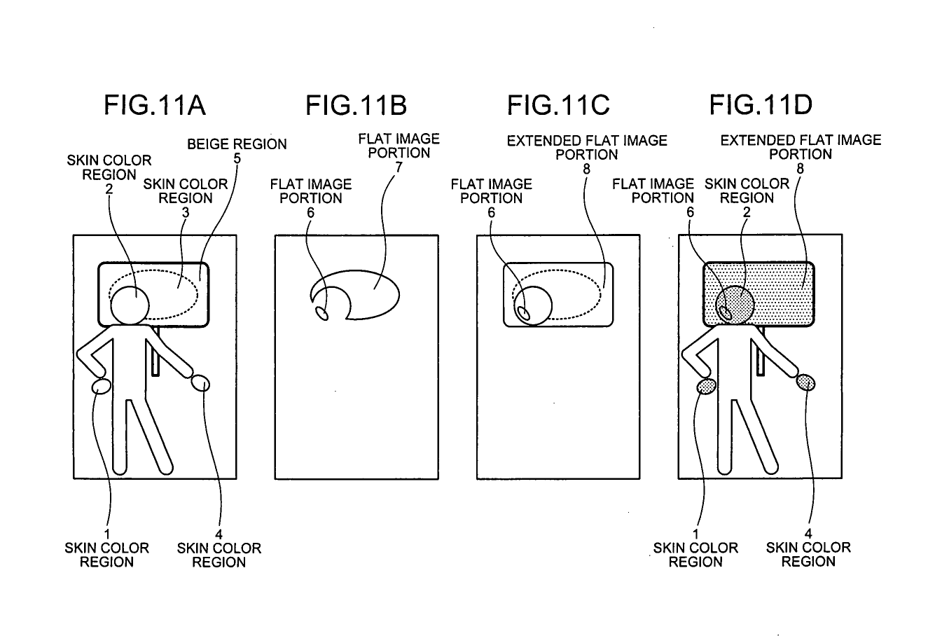

With reference to FIGS. 11A to 11D, an image correction apparatus according to the third embodiment will be described. FIGS. 11A to 11D are explanatory diagrams for an outline and characteristics of the image correction apparatus according to the third embodiment. As illustrated in FIGS. 11A to 11D, when an image is input (see FIG. 11A), the image correction apparatus according to the third embodiment detects a flat image portion from an image of a specific color region (see FIG. 11B).

The image correction apparatus according to the third embodiment compares a color variation amount of the detected flat image portion with a color variation amount of an adjacent portion adjacent to the flat image portion, and extends the flat image portion up to a region within which differences between the color variation amounts are equal to or less than a predetermined amount in the adjacent portion. More specifically, the image correction apparatus calculates a difference value by comparing the color variation amounts of pixels that form a flat image portion and the color variation amounts of pixels that form the adjacent image region. If the difference value is equal to or smaller than a predetermined value, the image correction apparatus integrates the adjacent image region to the flat image portion (extends the flat image portion), and if the difference value is larger than the predetermined value, the image correction apparatus does not integrate the adjacent image region to the flat image portion (does not extend the flat image portion). For example, as illustrated in FIGS. 11A to 11B, if the difference value of the color variations between the flat image portion 7 and the beige region 5 of the signboard in the background that is the adjacent image region is equal to or smaller than a predetermined value, the flat image portion 7 is extended to a boundary of the beige region 5 of the signboard in the background (see FIG. 11C).

The image correction apparatus according to the third embodiment measures the size of the extended flat image portion. More specifically, the image correction apparatus measures the size of the extended flat image portion as one. For example, the image correction apparatus measures the size of the extended flat image portion 8, regarding a boundary of the beige region 5 as a boundary of the flat image portion 7 and corrects the extended flat image portion 8 (see FIG. 11D).

As described above, according to the third embodiment, the image correction apparatus compares the color variation amounts between the detected flat image portion and the adjacent portion adjacent to the flat image portion, extends the flat image portion up to the region within which the differences between the color variation values is equal to or less than the predetermined amount in the adjacent portion, and measures the size of the extended flat image portion. Accordingly, when the specific color region is corrected, it is possible to correct a wider range and prevent an unnatural image including a prominent boundary in a part of the corrected background from being generated. In other words, for example, by correcting the adjacent region together with the flat image portion, in a region that has a possibility of having a prominent boundary due to correction, it is possible to prevent an unnatural image including a prominent boundary in a part of the corrected background from being generated.

### [d] Fourth Embodiment

The present invention may be implemented as various embodiments other than the above-described embodiments. A different embodiment will be described below as an image correction apparatus according to a fourth embodiment.

(1) Monochrome Image

In the above described embodiments, image correction is performed on color images (R, G, and B). However, the present invention is not limited to these embodiments, and image correction may be performed on a monochrome image.

More specifically, the image correction apparatus performs an image correction by detecting a specific gray scale region as a specific color region, and detecting a portion having a small gray scale variation amount as a flat image portion. The specific gray scale region may be an image region having a gray scale indicating a portion corresponding to a person photographed (skin color portion).

(2) System

All or part of the processes described in the above embodiments described as being automatically performed may be manually performed (for example, the size of the flat image portion may be measured manually, and the correction amount may be corrected manually). The information (such as FIGS. 1A to 1D, 3, 4, 5, and 6) including the procedural steps, the control steps, the specific terms, and the various data and parameters disclosed or illustrated can be arbitrarily changed, unless otherwise specified.

Each structural element of each apparatus illustrated is functional and/or conceptual, and not necessarily physically configured as illustrated. In other words, the specific mode of dispersion and integration of each device is not limited to the ones illustrated in the drawings, and all or a part thereof can be functionally or physically distributed or integrated in arbitrary units, depending on various kinds of loads and statuses of use (for example, the flat image portion detecting unit and the image correcting unit illustrated in FIG. 2 may be integrated, or the specific color region detecting unit may be distributed). All or an arbitrary part of the processing functions carried out in each device may be realized by a central processing unit (CPU) and a computer program or programs analyzed and executed by the CPU, or may be realized as wired logic hardware.

(3) Image Correction Processing Program

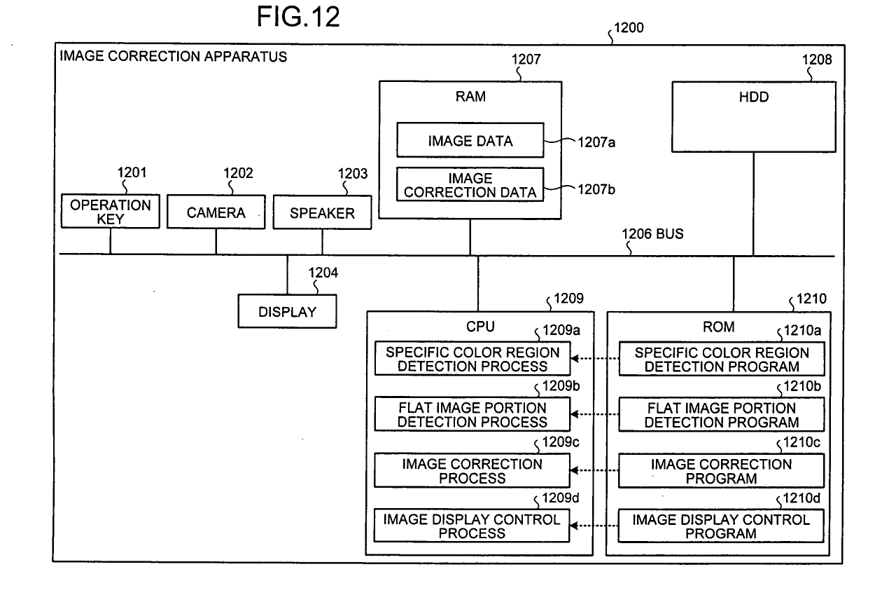

In the first embodiment, various processes are realized by hardware logic. However, the present invention is not limited to this embodiment, and the various processes may be realized by causing a computer to implement pre-provided computer programs. With reference to FIG. 12, an example of a computer that executes computer programs having the same functions as the image correction apparatus according to the first embodiment will now be described. FIG. 12 is an illustration of computer programs for the image correction apparatus according to the first embodiment.

As illustrated, the image correction apparatus 1200 is connected to an operation key 1201, a camera 1202, a speaker 1203, a display 1204, a random access memory (RAM) 1207, a hard disk drive (HDD) 1208, a CPU 1209, and a read-only memory (ROM) 1210, via a bus 1206. A specific color region detection program, a flat image portion detection program, an image correction program, and an image display control program that can exercise the same functions as the specific color region detecting unit 41, the flat image portion detecting unit 42, the image correcting unit 43, and the image display control unit 44 (for example, see FIG. 2) disclosed in the first embodiment are stored in the ROM 1210 in advance as illustrated in FIG. 12, as a specific color region detection program 1210a, a flat image portion detection program 1210b, an image correction program 1210c, and an image display control program 1210d The programs 1210a to 1210d may be integrated or distributed appropriately, like the image correction apparatus illustrated in FIG. 2.

The CPU 1209 reads the programs 1210a to 1210d from the ROM 1210 and executes the programs. Accordingly, as illustrated in FIG. 12, the programs 1210a to 1210d function as a specific color region detection process 1209a, a flat image portion detection process 1209b, an image correction process 1209c, and an image display control process 1209d. The processes 1209a to 1209d respectively correspond to the specific color region detecting unit 41, the flat image portion detecting unit 42, the image correcting unit 43, and the image display control unit 44 illustrated in FIG. 2.

The programs 1210a to 1210d described in the present embodiment need not be stored in the ROM in advance. For example, the programs 1210a to 1210d may be held by a “portable physical medium” such as a flexible disk, a compact disk read only memory (CD-ROM), an MO disk, a digital versatile disk (DVD), and an integrated circuit (IC) card that are insertable into the image correction apparatus; in a “fixed physical medium” such as an HDD provided inside or outside the image correction apparatus; or in “another computer (or server)” connected to an on-vehicle device 100 or a management center device 300 via a public line, the Internet, a local area network (LAN), and/or a wide area network (WAN), for example, so that the image correction apparatus can read and execute each computer program therefrom.

The image correction method described in the present embodiments may be realized by causing a computer such as a personal computer or a work station to implement the pre-provided computer programs. The computer programs may be distributed via a network such as the Internet. The computer programs may be recorded on a computer-readable recording medium such as a hard disk, a flexible disk (FD), a CD-ROM, an MO disk, and a DVD, and executed by being read out from the recording medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer readable storage medium containing instructions that, when executed by a computer, cause the computer to perform:
detecting a flat image portion having a color variation amount less than a predetermined amount from a specific color region having a specific color in an image;
measuring a size of the flat image portion detected; and
correcting the flat image portion by a first correction amount if the size of the flat image portion measured is larger than a predetermined value, and correcting the flat image portion by a second correction amount greater than the first second correction amount if the size of the flat image portion measured is not greater than the predetermined value.

2. The computer readable storage medium according to claim 1, wherein the measuring includes measuring, as the size of the flat image portion, a proportion of an area occupied by the flat image portion to an entire area of the image.

3. The computer readable storage medium according to claim 1, wherein the first correction amount is zero.

4. The computer readable storage medium according to claim 1, further containing instructions that cause the computer to further perform:
calculating a difference between a color variation amount in the flat image portion detected and a color variation amount of a pixel in an adjacent portion adjacent to the flat image portion;
extending the flat image portion by integrating the pixel to the flat image portion if the difference calculated is equal to or less than a predetermined difference, wherein
the measuring includes measuring a size of the extended flat image portion as the size of the flat image portion.

5. An image correction method comprising:
detecting a flat image portion having a color variation amount less than a predetermined amount from a specific color region having a specific color in an image;
measuring a size of the flat image portion detected; and
correcting the flat image portion by a first correction amount if the size of the flat image portion measured is larger than a predetermined value, and correcting the flat image portion by a second correction amount greater than the first second correction amount if the size of the flat image portion measured is not greater than the predetermined value.

6. An image correction apparatus comprising:
a detecting unit that detects a flat image portion having a color variation amount less than a predetermined amount from a specific color region having a specific color in an image;
a measuring unit that measures a size of the flat image portion detected by the detecting unit; and
a control unit that corrects the flat image portion by a first correction amount if the size of the flat image portion measured by the measuring unit is larger than a predetermined value, and corrects the flat image portion by a second correction amount greater than the first second correction amount if the size of the flat image portion measured by the measuring unit is not greater than the predetermined value.
